(19) United States
(12) Patent Application Publication
(10) Pub. No.: US 2008/0166509 A1
(43) Pub. Date: Jul. 10, 2008

(54) SILICONE TUBING FORMULATIONS AND METHODS FOR MAKING SAME

(75) Inventors: Mark W. Simon, Pascoag, RI (US); William J. Drummond, Bristol, RI (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 11/620,948

(22) Filed: Jan. 8, 2007

(51) Int. Cl. B32B 1/08; B29D 23/00; D01D 5/24

(52) U.S. Cl. 428/35.7; 264/209.6

(57) ABSTRACT

The disclosure is directed to a flex endurant tube including a blend of a silicone polymeric matrix material and a migrating component. The disclosure is further directed to methods for making the aforementioned tube.

### FIELD OF THE DISCLOSURE

This disclosure, in general, relates to silicone formulations for flex endurant tubes and methods for making said tubes.

### BACKGROUND

Peristaltic pumps are increasingly being used to move a variety of substances. Their applications range from biopharmaceuticals to the medical field to food processing. In essence, peristaltic pumps move materials, typically liquids, through a tube via a series of rollers and fixed pump housings. Hence, peristaltic pumps use tubes that are both flexible and resilient.

Silicone rubbers are typical materials used for peristaltic pump tubing due to their inherent flexibility. Unfortunately, silicone rubbers have poor tear strength and toughness. Upon repeated flex, silicone rubbers have a tendency to crack and burst. Hence, the silicone rubbers have a short life span as peristaltic pump tubing. In order to increase the life span of silicon rubbers in particular applications, silicone rubbers have been modified with various additives. Historically, various fillers and powders have been used to maintain the flexibility of silicone rubber while increasing its strength and toughness.

As such, it would be desirable to provide an improved silicone tubing and method for forming such a tubing.

### SUMMARY

In an embodiment, the disclosure is directed to a flex endurant tube including a blend that includes a silicone matrix material and a polar silicone.

In another exemplary embodiment, the disclosure is directed a method of making a tube. The method includes the steps of blending a silicone matrix material and a polar silicone. The method further includes extruding the blended silicone matrix material and polar silicone to produce a tube and curing said extruded tube.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary embodiment of a tube.

FIGS. 2, 3, 4, 5, and 6 include graphs illustrating the influence of a migrating component on the properties of silicone formulations.

The use of the same reference symbols in different drawings indicates similar or identical items.

### DETAILED DESCRIPTION OF THE DRAWINGS

In a particular embodiment, the disclosure is directed to a silicone-based formulation. The silicone-based formulation may, for example, be formed of a non-polar silicone matrix, such as a polyalkylsiloxane matrix, and a migrating component. In an exemplary embodiment, the migrating component is a polar low molecular weight silicone polymer. Such a silicone-based formulation may be useful in forming flex endurant composites for tubing. In an exemplary application, the silicone-based formulation is used to form flex endurant tubing for peristaltic pumps.

In an embodiment, the silicone-based formulation includes a silicone polymeric matrix. The polymeric matrix may be formed, for example, using a non-polar silicone polymer. The non-polar silicone polymer may, for example, include polyalkylsiloxane, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In general, the silicone polymer is non-polar and is free of halide functional groups, such as chlorine and fluorine, and is free of phenyl functional groups.

In an exemplary embodiment, the silicone polymer is a platinum catalyzed silicone formulation. Alternatively, the silicone polymer may be a peroxide catalyzed silicone formulation. The silicone polymer may be a liquid silicone rubber (LSR) or a high consistency gum rubber (HCR) silicone. In a particular embodiment, the silicone polymer is a platinum catalyzed HCR silicone, such as HCR silicone available from GE Plastics. In another example, the silicone polymer is an LSR formed from a two part reactive system. Particular embodiments of LSR include Wacker LR 3003-50 by Wacker Silicone of Adrian, Mich. and Rhodia 4360 by Rhodia Silicones of Ventura, Calif.

The silicone-based formulation may include a migrating component. In an exemplary embodiment, the migrating component is a polar component. Particular embodiments of the migrating component include polar silicone oils, such as silicone oils including halide functional groups, such as chlorine and fluorine, and silicone oils including phenyl functional groups. Generally, the migrating component is not terminated with reactive functional groups, such as vinyl and methoxy terminating functional groups. In an exemplary embodiment, the polar silicone is a fluorosilicone. For example, the migrating component may include low molecular weight trifluoropropylmethylsiloxane polymers. In another exemplary embodiment, the polar silicone is a phenyl silicone. For example, the migrating component may include low molecular weight polyphenylmethylsiloxane. For example, the low molecular weight migrating component may have a molecular weight not greater than about 25,000, such as not greater than about 10,000, or not greater than about 5,000.

In a further exemplary embodiment, the migrating component includes a hydrocarbon component. For example, the migrating component may be a hydrocarbon-based additive, such as a petrolatum, a paraffin-based wax, a hydrocarbon-based gel, a hydrocarbon-based oil, Vaseline®, and Amogell (available from Aldrich Chemical).

Typically, the migrating component exhibits a low viscosity at standard conditions prior to blending within the silicone polymeric matrix. For example, the migrating component may have a viscosity not greater than about 70,000 centipoise (cps), such as not greater than about 20,000 cps, or not greater than about 10,000 cps. In particular examples, migrating component exhibits a viscosity not greater than about 5,000 cps, such as not greater than about 1000 cps, not greater than about 500 cps, or even not greater than about 300 cps. In a particular embodiment, the migrating component exhibits a viscosity not greater than about 100 cps prior to blending with the silicone polymeric matrix. The migrating component is also thermally stable, remaining substantially intact and not substantially degrading at temperatures of at least about 170° C., such as at least about 200° C.

In an exemplary embodiment, the silicone formulation may be a blend of the silicone polymeric matrix and the migrating component. In particular, the silicone formulation is not a copolymer between the migrating component and the silicone polymeric matrix, (i.e., the silicone polymeric matrix is not cross-linked with the migrating component). In general, the migrating component is not substantially polymerized with the polyalkylsiloxane. In a particular embodiment, the silicone formulation forming the flex endurant tube is a non-polymerized blend of the silicone polymeric matrix and the migrating component. Here, “non-polymerized” denotes the migrating component not being appreciably polymerized with the matrix, although the matrix itself is generally deployed in the context of a flex endurant tube as a polymerized polymer and the migrating component may be a low molecular weight polymer.

In an particular embodiment, the silicone polymeric matrix is loaded with migrating component in amounts of about 0.1 wt % to about 10.0 wt %. Loading implies that the weight percent of migrating component is based on a weight of the silicone polymeric matrix component. For example, the silicone polymeric matrix may be loaded with migrating component in amounts of about 0.1 wt % to about 5.0 wt %, such as about 0.1 wt % to about 2.0 wt %, or about 0.5 wt % to about 2.0 wt %.

Migrating components may also be selected that have limited impact on physical properties of the silicone polymeric matrix. For example, migrating components may be selected such that they have limited impact on physical properties, such as tensile strength, tear strength, elongation, and durometer. In particular, low molecular weight polar silicones are selected that have limited impact on the physical properties of the silicone polymeric matrix, depending on loading. With loadings not greater than about 10.0 wt %, such as not greater than about 5.0 wt %, or not greater than about 1.0 wt %, the migrating component may impact the physical property by less than about 20%, such as not greater than about 15%, or not greater than about 10%. For example, a loading of fluorosilicone in a polyalkylsiloxane matrix, such as polydimethylsiloxane, in amounts not greater than about 5.0 wt % impacts tensile strength of the silicone-based formulation by not greater than about 15% and a loading of phenyl silicone impacts the silicone-based formulation by not greater than about 20%. In a further example, loading low molecular weight fluorosilicones or low molecular weight phenyl silicones in amounts not greater than about 5.0 wt % impact tear strength by not greater than about 15%, such as not greater than about 10%. In an additional exemplary embodiment, loadings not greater than about 5.0 wt % of fluorosilicone or phenyl silicone affects elongation properties by not greater than about 15%. In another example, such loadings of fluorosilicones or phenyl silicones in amounts not greater than about 5.0 wt % affects hardness properties, such as Shore A hardness, by not greater than about 10%.

Within the silicone polymeric matrix, the migrating component may exhibit migration as measured by Migration Index. In a particular embodiment, Migration Index is determined by the ratio of the coefficient of friction (COF) of the silicone polymeric matrix including the migrating component to the coefficient of friction of the silicone polymeric matrix without the migrating component. For example, the Migration Index may be determined by the formula:

$$Migration Index = \frac{COF of Matrix with Migrating Component}{COF of Matrix without Migrating Component}$$

The migrating component may, for example, exhibit a Migration Index not greater than about 0.6, such as about not greater than about 0.5, or not greater than about 0.4. In particular, low viscosity migrating components migrate to the surface of the silicone-based formulation and prevent cross-linking between surfaces. In an exemplary embodiment, when the silicon-based formulation of the disclosure is formed into a tube, the addition of the migrating component improves the coefficient of friction of the outside diameter of the tube, as well as the inside diameter of the tube. With an improved coefficient of friction on the surfaces of the tube, the tube has improved resiliency and withstands a greater amount of flexure.

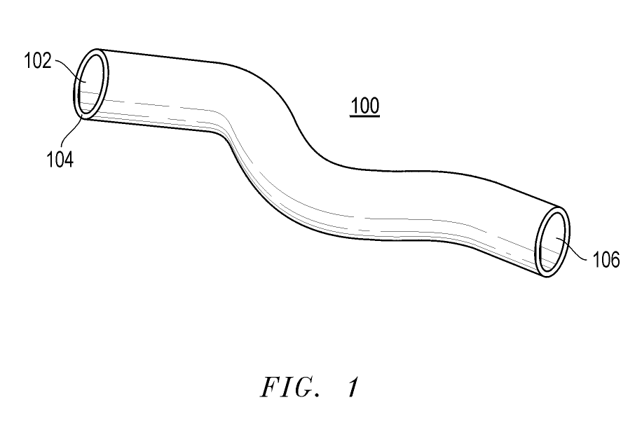

As stated earlier, the silicone formulation may be especially useful for use as tubing in peristaltic pump devices. FIG. 1 includes an exemplary embodiment of a tube 100. The tube 100 is an elongated annular structure with a hollow central bore 102. The tube 100 includes openings 104 and 106. In an embodiment, the tube 100 can be formed in lengths greater than 25 millimeters (mm), such as greater than 5 cm, or even greater than 25 cm. In an embodiment, the tubing 100 has a wall thickness of from about 1 mm to about 25 mm, such as from about 1 mm to about 10 mm.

The tube may be formed by a method that includes preparing a mixture of silicone precursors and the migrating component. For example, alkylsiloxane monomer, such as dimethylsiloxane, may be mixed with the migrating component. The mixture may further include catalysts and other additives. Exemplary additives may include, individually or in combination, fillers, colorants, and pigments. In an exemplary embodiment, the mixture is then extruded into tubing. Alternatively, the mixture may be molded. In an embodiment, the mixture may be molded at about 350° C. for about 15 minutes at about 1000 psi.

The tube may undergo additional curing or post-curing, such as through thermal treatments. For example, the tube may be treated at temperatures of at least about 170° C., such as at least about 200° C., or at least about 350° C. Typically, the post cure occurs for a time of from about 5 minutes to about 6 hours.

To further prepare the tube for use, the tube may be packaged. The addition of the migrating component allows the tube to be packaged without cross-linking of the surfaces of the tube when held in a fixed position. Hence, the shelf-life of the tube is increased with the addition of the migrating component.

In an embodiment of the disclosure, the tube may be sterilized. In a particular embodiment, the tube is irradiated with gamma radiation. For example, the tube may be irradiated with at least about 20 kGy, such as about 25 kGy, at least about 40 kGy, or at least about 47 kGy gamma radiation. In particular, the tube is irradiated without the application of external lubricants. As such, the tube is generally free of separately and externally applied lubricants. In an embodiment, sterilization may occur prior to packaging the tube. In an embodiment, sterilization may occur after packaging the tube.

Particular embodiments of the above-disclosed tubing advantageously exhibit an increased life over tubes without the migrating component. As stated earlier, particular embodiments of the silicone formulation of the disclosure exhibit an increase in tubing life when used in a peristaltic pump, as well as an increase in shelf-life in a packaged assembly. In an embodiment, a platinum catalyzed silicone provides particular processing advantages. In another embodiment, a high consistency rubber is particularly advantageous for forming tubing. In a further embodiment, a platinum catalyzed high consistency rubber is particularly advantageous for forming tubing having desirable properties.

### EXAMPLE 1

Low molecular weight polar siloxane fluids are tested as migrating additives in a high consistency rubber (HCR) gum base silicone. In the present example, about 5.0 weight % of a 500 centipoise (cps) polyphenylmethylsiloxane (PMM-0025 obtained from Gelest, Inc) is added to a platinum-catalyzed HCR gum base silicone on a two-roll mill. The resultant material is extruded into peristaltic pump tubing (0.250″×0.380″). The pump tubing is then post cured for about one hour in a box oven at about 177° C. for about 2 hours.

The tubing is evaluated in peristaltic pump testing using a MasterFlex pump drive (Cole Parmer) with a standard Master Flex 17 pump head designed for 0.250″×0.0380″ tubing dimensions. The tubing is loaded into the pump head using standard procedures suggested for the Cole Parmer pumps. Performance testing is done using a 600 rpm rotation speed of the pump head using water as pump media until failure of the tubing. Failure is defined as the time required for leakage detection using a Liqui-Sense leak detection system available from Cole Parmer. Flow rate is recorded at 24 hour intervals through the life of the tubing using an electronic flow meter.

The material is evaluated in its non-post cured form, post cured form, and after sterilization treatment. The sterilization treatment is performed using irradiation with gamma rays from a ⁶⁰Co-source and a minimum dose of 50 kGy. Table 1 illustrates the influence of the migrating additive on the peristaltic pump tubing. “Standard” represents the platinum-catalyzed HCR gum base silicone without the migrating additive.

TABLE 1
INFLUENCE OF ADDITIVE ON PRODUCT LIFE

| | Life (hours) | | |
|---|---|---|---|
| Product | Non-post cured | Post cured | Gamma radiation |
| Standard | 56.8 +/− 16.9 | 98.0 +/− 25.5 | 111.0 +/− 24.0 |
| Phenyl, | 130.2 +/− 30.6 | 153.0 +/− 32.0 | 253.0 +/− 91.0 |
| 500 cps | | | |

As illustrated, the addition of about 5.0 wt % polyphenylmethylsiloxane to the HCR base rubber silicone enhances the life of the peristaltic pump tube by about 129% in non-post cured tubing, greater than about 56% in post cured tubing, and about 128% in gamma sterilized tubing.

### EXAMPLE 2

In the present example, about 0.5 wt % of a 500 centipoise polyphenylmethylsiloxane (PMM-0025 obtained from Gelest, Inc) is added to a platinum-catalyzed HCR gum base silicone on a two-roll mill. The resultant material is extruded into peristaltic pump tubing (0.250″×0.380″) on a Davis-Standard extruder at 40 feet per minute. The product is cured in a 3 foot HAV IR furnace at temperatures between about 900° F. and about 1200° F. using a residence time of about 4.5 seconds. The tubing is post cured for about 2 hours at about 177° C. and the tubing is evaluated in peristaltic pump testing.

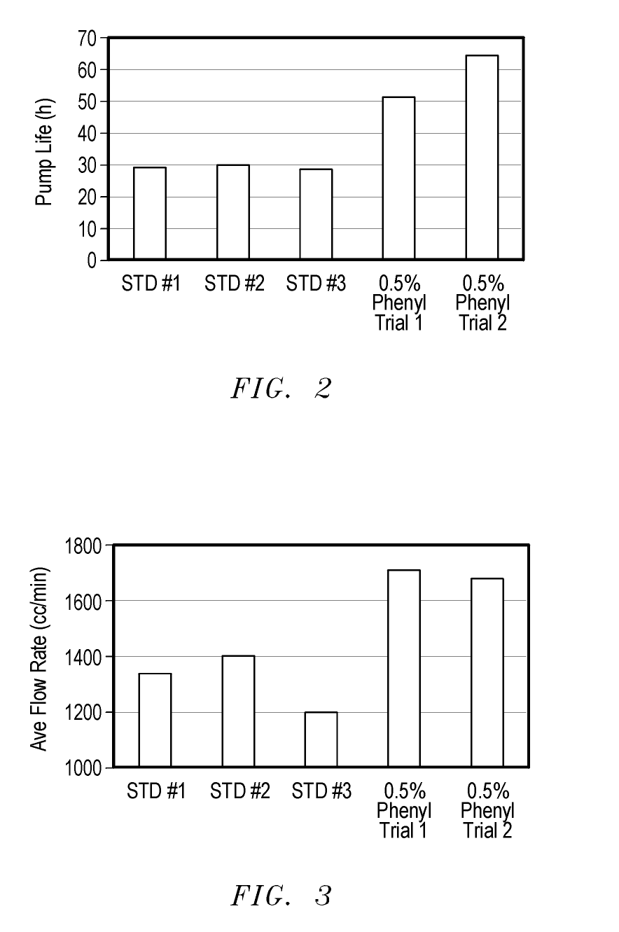

FIG. 2 illustrates the affects of the addition of the polyphenylmethylsiloxane on the life of the platinum-catalyzed HCR silicone. The increase in the life of the tube about 100% on average.

FIG. 3 and FIG. 4 illustrate the affects of the addition of the polyphenylmethylsiloxane on the flow rate consistency as well as the target flow rate values. Generally, the addition of the migrating component improves the flow rate of the tubing to about 1700 cc/min. In comparison to the Pt-catalyzed HCR silicone without the additive, the sample with the migrating component achieves a more consistent flow rate as well as a higher average flow rate.

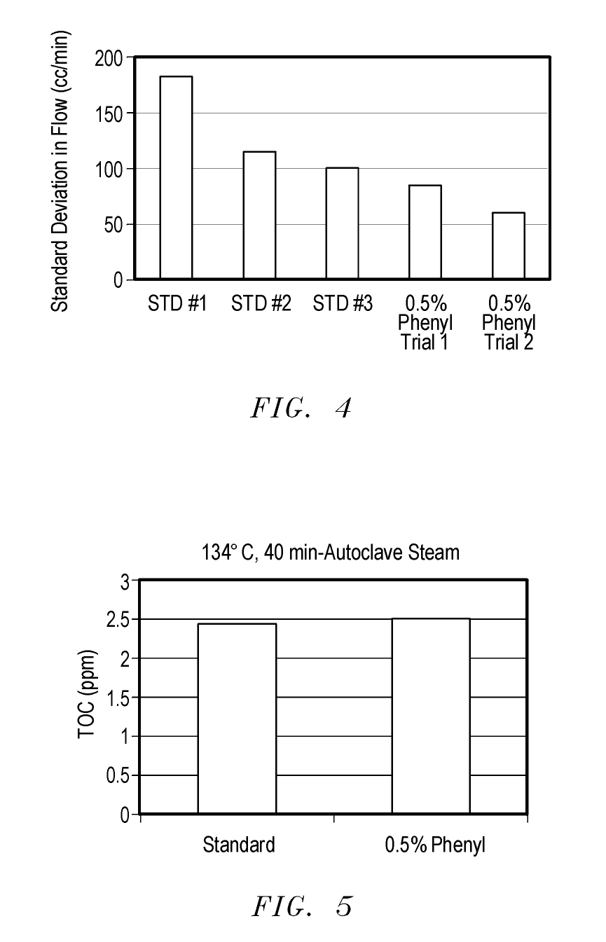

FIG. 5 illustrates the affects of the addition of the polyphenylmethylsiloxane on the total organic carbon (TOC) extractables content following steam sterilization in a 1 liter autoclave at 134° C. for 40 minutes. A temperature ramp is used to bring the internal temperature of the autoclave to 134° C. over a period of 35 minutes. The vessel is charged with 133 grams of deionized, distilled water. The tubing sample (8.00 g) is suspended above the water to expose it to the gas phase steam. After steam sterilizing, the vessel is cooled to room temperature and the aqueous condensate is removed and bottled for TOC testing. TOC concentrations are measured on a Phoenix 8000 TOC analyzer based on a persulfate-UV oxidation. Detection of carbon dioxide (CO₂) is made by infrared measurement. Generally, the addition of the migrating component minimally increases the extractables.

### EXAMPLE 3

Low molecular weight polar siloxane fluids are tested as migrating additives in a 50 durometer silicone rubber gum base. In particular, the silicone rubber is a platinum-catalyzed high consistency rubber (HCR) silicone. In the present example, about 5.0 weight % of a 500 centipoise (cps) polyphenylmethylsiloxane (PMM-0025 obtained from Gelest, Inc) is added to a platinum-catalyzed HCR gum base silicone on a two-roll mill. The resultant material is extruded into peristaltic pump tubing (0.250″×0.380″). The pump tubing is then post cured for about one hour in a box oven at about 177° C. for about 2 hours.

The material is evaluated in its non-post cured form, post cured form, and after sterilization treatment. The sterilization treatment is performed using irradiation with gamma rays from a ⁶⁰Co-source and a minimum dose of 50 kGy. Mechanical properties of the samples are tested such as tensile strength, flexural modulus and elongation at break on an Instron. The procedure follows ASTM D-638 using a Type V specimen. Tables 2, 3, and 4 illustrate the influence of the migrating additive on the mechanical properties of the peristaltic pump tubing. “Standard” represents the platinum-catalyzed HCR gum base silicone without the migrating additive.

TABLE 2
INFLUENCE OF ADDITIVE ON TENSILE STRENGTH

| | Tensile strength (Mpa) | | |
|---|---|---|---|
| Product | Non-post cured | Post cured | Gamma radiation |
| Standard | 7.9 +/− 0.37 | 8.73 +/− 0.87 | 8.06 +/− 0.51 |
| Phenyl, 500 cps | 7.21 +/− 0.29 | 7.3 +/− 0.2 | 7.21 +/− 0.21 |

TABLE 3
INFLUENCE OF ADDITIVE ON ELONGATION-AT-BREAK

| | Elongation at break (%) | | |
|---|---|---|---|
| Product | Non-post cured | Post cured | Gamma radiation |
| Standard | 865 | 713 | 440 |
| Phenyl, 500 cps | 794 | 790 | 478 |

TABLE 4
INFLUENCE OF ADDITIVE ON FLEXURAL MODULUS

| | Modulus (MPa) | | |
|---|---|---|---|
| Product | Non-post cured | Post cured | Gamma radiation |
| Standard | 2.07 | 3.26 | 4.09 |
| Phenyl, 500 cps | 2.17 | 2.75 | 3.57 |

Generally, the addition of the migrating component minimally influences the mechanical properties of the tubing.

### EXAMPLE 4

Low molecular weight polar siloxane fluids are tested as migrating components in liquid silicone rubber (LSR). Formulations include a two part LSR system having part A including a platinum based catalyst and a vinyl based rubber and part B including a hydride cross-linking agent, a catalyst inhibitor and a vinyl based rubber. About 300 grams of LSR part A and about 300 grams of LSR part B and a specific amount of migrating component are mixed in a five quart bowl using a Kitchen-Aid mixer on a low setting for twelve minutes under vacuum (25 in Hg). In particular, a migrating component, such as a polytrifluoropropylmethylsiloxane from manufacturers, such as Gelest (FMS-121 and FMS-123) and NuSil (MED 400 and MED 400-100); or a polyphenylmethylsiloxane by Gelest (PMM-0025) and NuSil (S-7400) are added. The mixer is stopped at four-minute intervals to scrape down silicone off the walls of the mixing pan. Mixing is resumed and allowed to continue under vacuum for a total of twelve minutes. Seventy grams of blended silicone rubber is placed onto Mylar sheets coated with mold-release solution (i.e., water, IPA, and surfactant). The rubber is pressed to approximately fill the mold cavity. The mold is closed and loaded into a 166° C. pre-heated press and immediately pressure is applied to the mold (25 tons) to avoid scorching. The material is cured under pressure at a temperature for five minutes. The molded part is removed from the mold and post-cured in a box oven for about four hours at about 177° C.

Migration Index is measured using coefficient friction. Coefficient of friction measurements are performed using a Falex Wear and Friction tester. A one-pound load is used at a rotational rate of 50 rpm.

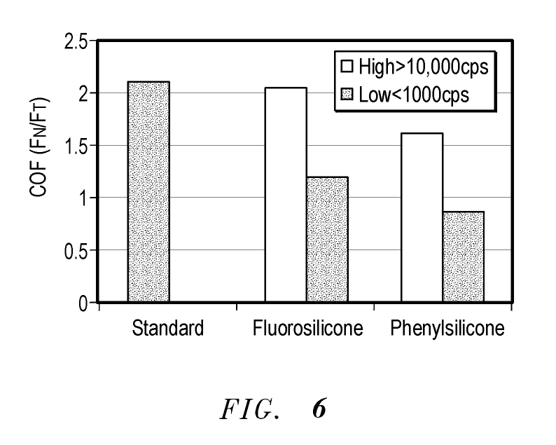

Migration Index of additives is influenced by the viscosity of the pure additive component prior to mixing into the silicone formulation. FIG. 6 illustrates the coefficient of friction for additives having different viscosity. High viscosity (>10,000 cps) fluorosilicone and phenylsilicone additives have higher coefficients of friction than low viscosity (<1000 cps) additives. In fact, the Migration Index of high viscosity fluorosilicone is nearly 1, while the Migration Index of low viscosity fluorosilicone is not greater than about 0.6. The Migration Index of low viscosity phenylsilicone is not greater than about 0.5, and, in some embodiments, is less than 0.4.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A flex endurant tube comprising a blend including a silicone polymeric matrix material and a polar silicone.

2. The flex endurant tube of claim 1, wherein the polar silicone comprises a phenylsilicone.

3. (canceled)

4. The flex endurant tube of claim 1, where the polar silicone comprises a fluorosilicone.

5. (canceled)

6. The flex endurant tube of claim 2, wherein the polar silicone has a viscosity not greater than about 70,000 centipoise.

7. The flex endurant tube of claim 6, wherein the viscosity is not greater than about 10,000 centipoise.

8. (canceled)

9. The flex endurant tube of claim 1, wherein the blend comprises a loading of polar silicone of about 0.1 wt % to about 10.0 wt % based on the weight of the silicone polymeric matrix material.

10. The flex endurant tube of claim 9, wherein the blend comprises a loading of polar silicone of about 0.1 wt % to about 5.0 wt % based on the weight of the silicone polymeric matrix material.

11. (canceled)

12. The flex endurant tube of claim 1, wherein the silicone polymeric matrix material comprises a non-polar silicone.

13. The flex endurant tube of claim 12, wherein the non-polar silicone comprises a polyalkoxysiloxane.

14. (canceled)

15. (canceled)

16. The flex endurant tube of claim 1, wherein the blend is non-polymerized.

17. The flex endurant tube of claim 1, wherein said flex endurant tube is used for pumping fluids by means of a peristaltic pump.

18. The flex endurant tube of claim 1, wherein said tube is an elongated annular structure having a hollow central bore.

19. The flex endurant tube of claim 1, wherein said tube has a length of greater than about 25 mm.

20. (canceled)

21. (canceled)

22. (canceled)

23. A flex endurant tube comprising a non-polymerized blend including a polyalkoxysiloxane and poly trifluoropropylmethylsiloxane.

24. The flex endurant tube of claim 23, wherein the non-polymerized blend comprises a loading of poly trifluoropropylmethylsiloxane of about 0.1 wt % to about 1.0 wt % based on the weight of the polyalkoxysiloxane.

25. The flex endurant tube of claim 23, where in the poly trifluoropropylmethylsiloxane has a viscosity not greater than about 1,000 centipoise.

26. A method of making a tube, the method comprising:
blending a silicone polymeric matrix material and a polar silicone;
extruding the blended silicone polymeric matrix material and polar silicone to produce a tube; and
curing said extruded tube.

27. The method of claim 26, wherein the blend comprises a loading of polar silicone of about 0.1 wt % to about 10.0 wt % based on the weight of the silicone polymeric matrix material.

28. The method of claim 27, wherein the blend comprises a loading of polar silicone of about 0.1 wt % to about 5.0 wt % based on the weight of the silicone polymeric matrix material.

29. (canceled)

30. (canceled)

31. The method of claim 26, wherein the silicone polymeric matrix material comprises a non-polar silicone.

32. (canceled)

33. (canceled)

34. (canceled)

35. (canceled)

36. (canceled)

37. The method of claim 26, where the polar silicone comprises a fluorosilicone.

38. (canceled)

39. (canceled)

40. (canceled)
